(19) United States
(12) Patent Application Publication
(10) Pub. No.: US 2026/0001765 A1
(43) Pub. Date: Jan. 1, 2026

(54) MODIFIED POROUS LITHIUM IRON PHOSPHATE AND PREPARATION METHOD AND USE THEREOF

(71) Applicant: EVE POWER CO., LTD., Jingmen (CN)

(72) Inventors: Xu XING, Jingmen (CN); Haitao WEI, Jingmen (CN); Ke GUI, Jingmen (CN); Weihua ZHU, Jingmen (CN); Kai WANG, Jingmen (CN)

(73) Assignee: EVE POWER CO., LTD., Jingmen (CN)

(21) Appl. No.: 19/318,246

(22) Filed: Sep. 3, 2025

Related U.S. Application Data
(63) Continuation of application No. PCT/CN2023/137293, filed on Dec. 7, 2023.

(30) Foreign Application Priority Data
Mar. 3, 2023 (CN) 202310196547.2

(51) Int. Cl. C01B 25/45; H01M 10/0525

(52) U.S. Cl. CPC C01B 25/45; H01M 10/0525; C01P 2004/03; C01P 2006/40

(57) ABSTRACT

A modified porous lithium iron phosphate and a preparation method and applications thereof are provided. The preparation method includes the following steps: mixing a porous iron phosphate precursor, a lithium source, a reducing agent and lithium fluoride to grind; pre-sintering a material obtained by the grinding treatment to obtain a pre-sintered material; and mixing the pre-sintered material with a carbon source to calcine to obtain the modified porous lithium iron phosphate.

### CROSS REFERENCE TO RELATED APPLICATIONS

This application is a continuation application of International Application No. PCT/CN2023/137293, filed on Dec. 7, 2023, which claims priority to Chinese Patent Application No. 202310196547.2 filed with China National Intellectual Property Administration on Mar. 3, 2023, the entire contents of which are incorporated herein by reference.

### TECHNICAL FIELD

The present disclosure belongs to the technical field of lithium-ion batteries, and relates to a modified porous lithium iron phosphate and a preparation method and applications thereof.

### BACKGROUND

There are many methods for improving the surface carbon coating and particle morphology of Lithium iron phosphate (LiFePO₄), for example, by distorting the lattice through ion doping and reducing polarization and charge transfer resistance, not only can the electronic conductivity of LiFePO₄ be improved, but also the diffusion of lithium ions can be promoted.

By doping ions inside the LiFePO₄ lattice to replace the positions of Li, Fe, and O, the doped metal must match the lattice of LiFePO₄. In the related art, ions with a radius close to the radius of the substitution position may be doped. Fe-bit doping is the substitution of Fe with metal cations in the crystal structure. However, the Fe-bit doping will weaken the interaction of Li—O bond. When substitution of different valence states is used, ion vacancies or ionic valence changes will be generated, thereby increasing the diffusion path of lithium ions and improving the mobility and diffusion coefficient of ions.

In the related art, the lithium iron phosphate cathode material has a low Li⁺ diffusion coefficient, resulting in poor electrochemical performance of the material.

### SUMMARY

In a first aspect, the embodiments of the present disclosure provide a preparation method of a modified porous lithium iron phosphate, where the preparation method includes:
mixing a porous iron phosphate precursor, a lithium source, a reducing agent, and lithium fluoride to grind;
pre-sintering a material obtained by the grinding treatment to obtain a pre-sintered material; and
mixing the pre-sintered material with a carbon source to calcine to obtain the modified porous lithium iron phosphate.

In a second aspect, the embodiments of the present disclosure provide a modified porous lithium iron phosphate prepared by the method according to the first aspect.

In a third aspect, the embodiments of the present disclosure provide a positive electrode plate, where the positive electrode plate includes the modified porous lithium iron phosphate according to the second aspect.

In a fourth aspect, the embodiments of the present disclosure provide a lithium-ion battery, where the lithium-ion battery includes the positive electrode plate according to the third aspect.

### BRIEF DESCRIPTION OF THE DRAWINGS

FIG. 1 is a schematic flowchart of a preparation method of a modified porous lithium iron phosphate according to an embodiment of the present disclosure.

FIG. 2 is a scanning electron microscopy (SEM) image of a modified porous lithium iron phosphate according to Embodiment 1 of the present disclosure.

FIG. 3 is a cycle performance diagram of a modified porous lithium iron phosphate according to Embodiment 1 of the present disclosure.

FIG. 4 is a comparison diagram of the rate capability of the lithium iron phosphate cathode materials prepared by Embodiment 1 and Comparative Example 1.

FIG. 5 a linear relationship diagram of the peak current (ip) and the square root of scan rate (v^{1/2}) of the lithium iron phosphate cathode materials prepared by Embodiment 1 and Comparative Example 1.

### DETAILED DESCRIPTION

The present disclosure provides a modified porous lithium iron phosphate and a preparation method and applications thereof, and the embodiments of the present disclosure directly perform fluorine-oxygen site doping on iron phosphate, which can prepare porous lithium iron phosphate with excellent electrochemical performance. The prepared material has the advantages of good electrical conductivity and high ion diffusion coefficient.

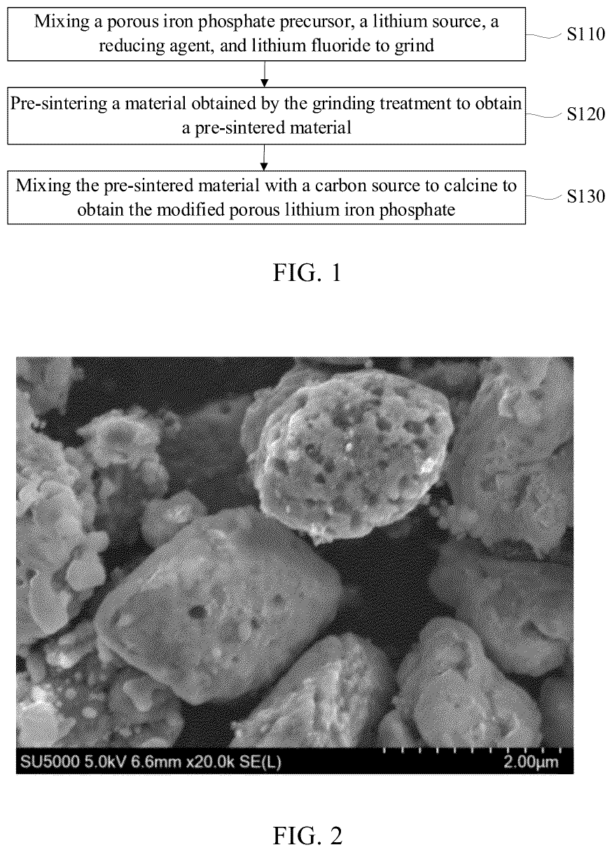

Referring to FIG. 1, FIG. 1 is a schematic flowchart of preparation method of a modified porous lithium iron phosphate according to an embodiment of the present disclosure. The preparation method of the modified porous lithium iron phosphate includes the following steps S110 to S130.

At step S110, a porous iron phosphate precursor, a lithium source, a reducing agent, and lithium fluoride is mixed to grind.

At step S120, the material obtained by the grinding treatment is pre-sintered to obtain a pre-sintered material.

At step S130, the obtained pre-sintered material is mixed with a carbon source to calcine to obtain the modified porous lithium iron phosphate, which may be used as a cathode material.

In the process of preparing lithium iron phosphate, the embodiments of the present disclosure use a porous iron phosphate precursor and directly perform oxygen-site fluorine doping on the porous iron phosphate precursor. The porous structure provides a more stable diffusion channel for Li⁺. The doping of F element further increases the area of the Li⁺ migration channel, resulting in an increase in the Li⁺ diffusion coefficient and an improvement in the electrochemical performance of the material.

In some embodiments of the present disclosure, the F element doped in lithium iron phosphate not only improves the electron conductivity of carbon by changing the electron structure of the carbon film in the carbon film formed by melting glucose, but also but also promotes the intercalation/deintercalation kinetics of Li⁺ in the carbon film by providing defects and vacancies, thereby facilitating the diffusion of Li⁺. On the other hand, F doping modifies the microstructure of LiFePO₄ by weakening the Li—Fe—O bonds, thus improving the diffusion of Li⁺ in LiFePO₄, enabling the F-doped LiFePO₄ to exhibit stable cycling ability and high-rate performance.

In some embodiments, the molar ratio of the lithium source to the porous iron phosphate precursor is in a range of 1.05:1 to 1.1:1, such as, 1.05:1, 1.06:1, 1.07:1, 1.08:1, 1.09:1, or 1.1:1, etc.

In some embodiments, the reducing agent includes ascorbic acid.

In some embodiments, the mass of the reducing agent is 8% to 12% of the sum of masses of the lithium source and the porous iron phosphate precursor, such as 8%, 9%, 10%, 11%, or 12%, etc.

In some embodiments, the molar ratio of the fluorine element in the lithium fluoride to the oxygen element in the porous iron phosphate precursor is in a range of 0.01:4 to 0.05:4, such as 0.01:4, 0.02:4, 0.03:4, 0.04:4, or 0.05:4, etc.

In some embodiments, a period of time for the grinding treatment is 20 minutes to 40 minutes, such as 20 minutes, 25 minutes, 30 minutes, 35 minutes, or 40 minutes, etc.

In some embodiments, a temperature for the pre-sintering treatment is 300°° C. to 400° C., such as 300° C., 320° C., 350° C., 380° C., or 400° C., etc.

In some embodiments, a period of time for the pre-firing treatment is 3 hours to 8 hours, such as 3 hours, 4 hours, 5 hours, 6 hours, 7 hours, or 8 hours, etc.

In some embodiments, the atmosphere for the pre-firing treatment includes argon.

In some embodiments, the carbon source includes glucose.

In some embodiments, the mass of the carbon source is 8% to 12% of the sum of masses of the lithium source and the porous iron phosphate precursor, such as 8%, 9%, 10%, 11%, or 12%, etc.

In some embodiments, a temperature for the calcining treatment is 600° C. to 700° C., such as 600° C., 620° C., 650° C., 680° C., or 700° C., etc.

In some embodiments, a period of time for the calcining treatment is 8 to 12 hours, such as 8 hours, 9 hours, 10 hours, 11 hours, or 12 hours, etc.

The embodiments of the present disclosure further provide a modified porous lithium iron phosphate prepared by the above method.

In some embodiments, the chemical formula of the modified porous lithium phosphate is LiFePO₄₋ₓFₓ/C, where x ranges from 0.01 to 0.05.

In a specific embodiment, the chemical formula of the modified porous lithium phosphate is LiFePO_{3.97}F_{0.03}/C, and LiFePO_{3.97}F_{0.03}/C can maintain the porous morphology of the composite material. The porous morphology is beneficial for the coating of molten glucose and the doping of F element.

The embodiments of the present disclosure further provide a positive electrode plate, where the positive electrode plate includes the modified porous lithium iron phosphate described above.

The embodiments of the present disclosure further provide a lithium-ion battery, where the lithium-ion battery includes the foregoing positive electrode plate.

### Embodiment 1

Embodiment 1 provides a modified porous lithium iron phosphate, and the preparation method of the modified porous lithium iron phosphate is as follows.

At step (1), 0.5 g of a porous FePO4 precursor and 0.1391 g of LiOH·H₂O were respectively weighed in a molar ratio of P:Li being 1:1; 0.06391 g of reducing agent ascorbic acid was weighed, where the mass of ascorbic acid was determined based on 10% of the sum of masses of LiOH·H₂O and the porous FePO₄; and 0.0026 g of LiF was weighed, where the mass of LiF was determined based on a molar ratio of fluorine (F) in LiF to oxygen (O) in FePO₄ of 0.03:3.97; then, the weighed porous FePO₄ precursor, LiOH·H₂O, ascorbic acid and LiF were added to an agate mortar, and then the agate mortar was placed in an infrared oven for grinding for 30 minutes.

At step (2), the material obtained in step (1) was heated to 350° C. at a heating rate of 6° C./min for pre-sintering for 5 hours to obtain a pre-sintered material.

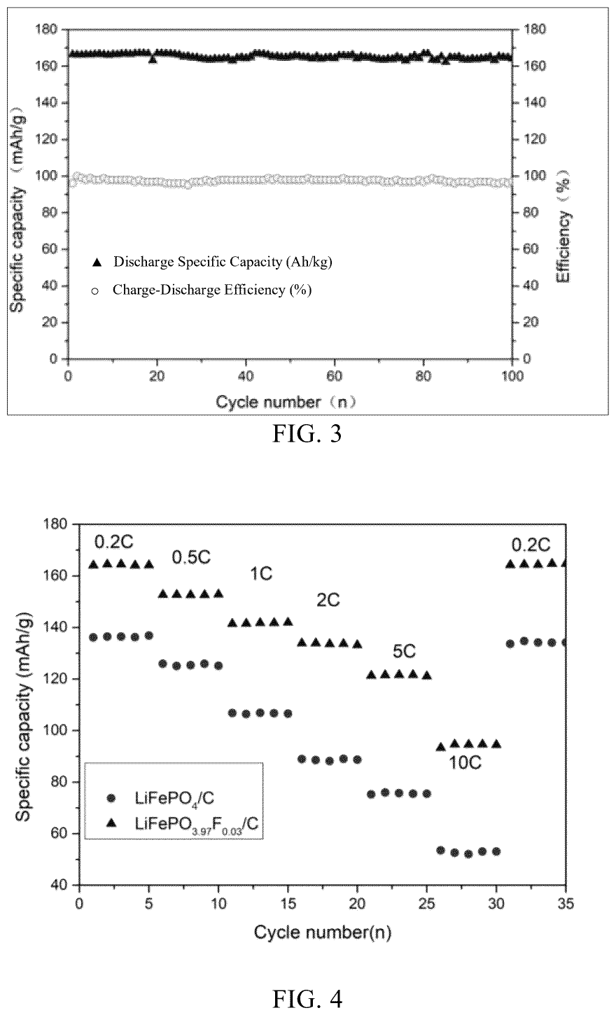

At step (3), 0.0639 g of glucose (weighed according to 10% of the sum of masses of LiOH·H₂O and the porous FePO₄) was added to the agate mortar with the pre-sintered material for grinding for 20 minutes, and then the agate mortar was put into a tube furnace under argon atmosphere, and was heated to 650° C. at a heating rate of 6° C./min for calcining for 10 hours to obtain the modified porous lithium iron phosphate, where the chemical formula of the modified porous lithium iron phosphate is LiFePO_{3.97}F_{0.03}/C, and the SEM image of the modified porous lithium iron phosphate is shown in FIG. 2. A cycle performance diagram of the modified porous lithium iron phosphate is shown in FIG. 3.

### Embodiment 2

Embodiment 2 provides a modified porous lithium iron phosphate, and the preparation method of the modified porous lithium iron phosphate is as follows.

At step (1), 0.5 g of a porous FePO4 precursor and 0.1391 g of LiOH·H₂O were respectively weighed in a molar ratio of P:Li being 1:1; 0.06391 g of reducing agent ascorbic acid was weighed, where the mass of ascorbic acid was determined based on 10% of the sum of masses of LiOH·H₂O and the porous FePO₄; and 0.0035 g of LiF was weighed, where the mass of LiF was determined based on a molar ratio of fluorine (F) in LiF to oxygen (O) in FePO₄ of 0.04:3.96; then, the weighed porous FePO₄ precursor, LiOH·H₂O, ascorbic acid and LiF were added to an agate mortar, and then the agate mortar was placed in an infrared oven for grinding for 30 minutes.

At step (2), the material obtained in step (1) was heated to 360° C. at a heating rate of 6° C./min for pre-sintering for 5.2 hours to obtain a pre-sintered material.

At step (3), 0.0639 g of glucose (weighed according to 10% of the sum of masses of LiOH·H₂O and the porous FePO₄) was added to the agate mortar with the pre-sintered material for grinding for 20 minutes, and then the agate mortar was put into a tube furnace under argon atmosphere, and was heated to 680° C. at a heating rate of 6° C./min for calcining for 9 hours to obtain the modified porous lithium iron phosphate, where the chemical formula of the modified porous lithium iron phosphate is LiFePO_{3.96}F_{0.04}/C.

### Embodiment 3

Embodiment 3 differs from Embodiment 1 only in that the molar ratio of fluorine (F) LiF to oxygen (O) in FePO₄ was 0.08:3.92, and other conditions and parameters were completely the same as those in Embodiment 1.

### Embodiment 4

Embodiment 4 differs from Embodiment 1 only in that the molar ratio of fluorine (F) in LiF to oxygen (O) in FePO₄ was 0.005:3.995, and other conditions and parameters were completely the same as those in Embodiment 1.

### Comparative Example 1

Comparative Example 1 differs from Embodiment 1 only in that no fluorine doping was performed (that is, no LiF is added), and other conditions and parameters were completely the same as those in Embodiment 1.

### Comparative Example 2

Comparative Example 2 differs from Embodiment 1 only in that conventional iron phosphate was used instead of porous iron phosphate, and other conditions and parameters were completely the same as those in Embodiment 1.

### Performance Test

The modified porous lithium iron phosphate prepared in Embodiment 1-4 and the lithium iron phosphate prepared in Comparative Example 1-2 were respectively used as a lithium iron phosphate cathode material for performance testing. Specifically, the lithium iron phosphate cathode material, conductive carbon black (SuperP), and polyvinylidene fluoride (PVDF) in a mass ratio of 8:1:1 were mixed with N-methylpyrrolidone (NMP solvent) to prepare an electrode slurry, and the electrode slurry was coated uniformly on an aluminum foil, then was dried in a vacuum drying oven. Then the dried aluminum foil coated with the electrode slurry was prepared into an electrode plate with a diameter of 12 mm by using a microtome, and the electrode plate was assembled into a lithium half-cell in an argon-filled vacuum glove box. The above lithium-half-cell was subjected to a cycle performance test of 100 charge-discharge cycles at a rate of 0.2 C, and a 0.2 C-10 C rate test was performed, and the test results are shown in Table 1.

TABLE 1

| | Capacity Retention Rate | 10 C Discharge |
|---|---|---|
| | after 100 Cycles | Capacity |
| Embodiment 1 | 99.1% | 74.6 mAh/g |
| Embodiment 2 | 98.8% | 69.5 mAh/g |
| Embodiment 3 | 98.6% | 65.3 mAh/g |
| Embodiment 4 | 98.4% | 66.2 mAh/g |
| Comparative Example 1 | 97.1% | 50.6 mAh/g |
| Comparative Example 2 | 97.3% | 58.6 mAh/g |

It can be seen from Table 1 that, as can be seen from Embodiments 1 and 2, in the embodiments of the present disclosure, the capacity retention rate of the modified porous lithium iron phosphate after 100 cycles can reach over 98.8%, the discharge capacity at 10 C can reach over 69.5 mAh/g. By adjusting the preparation parameters of the modified porous lithium iron phosphate, the capacity retention rate after 100 cycles can reach over 99.1%, and the discharge capacity at 10C can reach 74.5 mAh/g.

From the comparison of Embodiment 1 with Embodiments 3 and 4, in the preparation process of the modified porous lithium iron phosphate in the embodiments of the present disclosure, the molar ratio of the fluorine in the added lithium fluoride and the oxygen in the porous iron phosphate precursor will affect the performance of the prepared modified porous lithium iron phosphate. Controlling the molar ratio of fluorine in lithium fluoride to oxygen in the porous iron phosphate precursor to be within the range of 0.01:4 to 0.05:4 can result in better performance of the modified porous lithium iron phosphate. If the addition amount of lithium fluoride is too large, the distribution of fluorine element will be too high and concentrated on the surface, which will affect the transfer of Li⁺. If the addition amount of lithium fluoride is too small, the doping effect will be limited, and the fluorine element cannot be uniformly distributed.

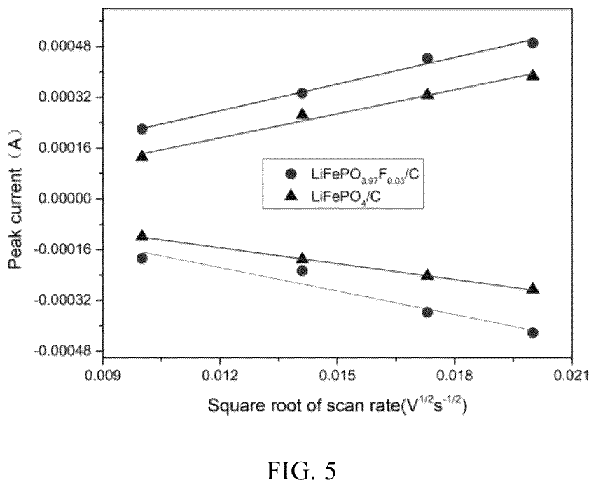

The comparison of the rate capability of the lithium iron phosphate cathode materials prepared in Embodiment 1 and Comparative Example 1 is shown in FIG. 4, and it can be seen from FIG. 4 that the discharge capacities of the porous LiFePO_{3.97}F_{0.03}/C composite material at different rates are all greater than those of the porous LiFePO₄/C. The linear relationship between the square root (v^{1/2}) of scan rate and the peak current (ip) of the lithium iron phosphate cathode materials prepared in Embodiment 1 and Comparative Example 1 are as shown in FIG. 5, and combined with the Randles-Sevcik equation ip=2.69×10⁵n^{3/2}AC₀D^{1/2}v^{1/2}, it is concluded that the diffusion coefficients of Li⁺ corresponding to the oxidation and reduction reactions of the LiFePO_{3.97}F_{0.03}/C composite material are 1.63×10⁻¹¹ cm²/s and 1.261×10⁻¹¹ cm²/s, respectively. The diffusion coefficients of Li⁺ corresponding to the oxidation and reduction reactions of LiFePO₄/C composite material are 1.329×10⁻¹¹ cm²/s and 6.037×10⁻¹¹ cm²/s, respectively. The diffusion coefficients of Li⁺ of LiFePO_{3.97}F_{0.03}/C at the oxidation peak and the reduction peak are superior to those of LiFePO₄/C.

From the comparison between Example 1 and Comparative Example 2, In the process of preparing lithium iron phosphate, the embodiments of the present disclosure use a porous iron phosphate precursor and directly perform oxygen-site fluorine doping on the porous iron phosphate precursor. The porous structure provides a more stable diffusion channel for Li⁺. The doping of F element further increases the area of the Li⁺ migration channel, resulting in an increase in the Li⁺ diffusion coefficient and an improvement in the electrochemical performance of the material.

What is claimed is:

1. A preparation method of a modified porous lithium iron phosphate, comprising:
mixing a porous iron phosphate precursor, a lithium source, a reducing agent, and lithium fluoride to grind;
pre-sintering a material obtained by the grinding treatment to obtain a pre-sintered material; and
mixing the pre-sintered material with a carbon source to calcine to obtain the modified porous lithium iron phosphate.

2. The preparation method according to claim 1, wherein a molar ratio of the lithium source to the porous iron phosphate precursor is 1.05:1 to 1.1:1.

3. The preparation method according to claim 1, wherein the reducing agent comprises ascorbic acid.

4. The preparation method according to claim 1, wherein a mass of the reducing agent is 8% to 12% of a sum of masses of the lithium source and the porous iron phosphate precursor.

5. The preparation method according to claim 1, wherein a molar ratio of fluorine in lithium fluoride to oxygen in the porous iron phosphate precursor is 0.01:4 to 0.05:4.

6. The preparation method according to claim 1, wherein a period of time for the grinding treatment is 20 minutes to 40 minutes; and/or a temperature for the pre-sintering treatment is 300° C. to 400° C., and a period of time for the pre-sintering treatment is 3 hours to 8 hours.

7. The preparation method according to claim 1, wherein an atmosphere for the pre-sintering treatment comprises argon.

8. The preparation method according to claim 1, wherein the carbon source comprises glucose.

9. The preparation method according to claim 1, wherein a mass of the carbon source is 8% to 12% of a sum of masses of the lithium source and the porous iron phosphate precursor.

10. The preparation method according to claim 1, wherein a temperature for the calcining treatment is 600° C. to 700° C.; and a period of time for the calcining treatment is 8 hours to 12 hours.

11. A modified porous lithium iron phosphate, wherein a preparation method of the modified porous lithium iron phosphate comprises:
mixing a porous iron phosphate precursor, a lithium source, a reducing agent, and lithium fluoride to grind;
pre-sintering a material obtained by the grinding treatment to obtain a pre-sintered material; and
mixing the pre-sintered material with a carbon source to calcine to obtain the modified porous lithium iron phosphate.

12. The modified porous lithium iron phosphate according to claim 11, wherein a molar ratio of the lithium source to the porous iron phosphate precursor is 1.05:1 to 1.1:1; and/or
wherein the carbon source comprises glucose, and a mass of the carbon source is 8% to 12% of a sum of masses of the lithium source and the porous iron phosphate precursor.

13. The modified porous lithium iron phosphate according to claim 11, wherein the reducing agent comprises ascorbic acid; and wherein a mass of the reducing agent is 8% to 12% of a sum of masses of the lithium source and the porous iron phosphate precursor.

14. The modified porous lithium iron phosphate according to claim 11, wherein a molar ratio of fluorine in lithium fluoride to oxygen in the porous iron phosphate precursor is 0.01:4 to 0.05:4.

15. The modified porous lithium iron phosphate according to claim 11, wherein the modified porous lithium iron phosphate has a chemical formula of LiFePO₄₋ₓFₓ/C, wherein x ranges from 0.01 to 0.05.

16. The modified porous lithium iron phosphate according to claim 15, wherein the modified porous lithium iron phosphate has a chemical formula of LiFePO_{3.97}F_{0.03}/C.

17. A positive electrode plate, comprising a modified porous lithium iron phosphate, wherein a preparation method of the modified porous lithium phosphate comprises:
mixing a porous iron phosphate precursor, a lithium source, a reducing agent, and lithium fluoride to grind;
pre-sintering a material obtained by the grinding treatment to obtain a pre-sintered material; and
mixing the pre-sintered material with a carbon source to calcine to obtain the modified porous lithium iron phosphate.

18. The positive electrode plate according to claim 17, wherein the modified porous lithium iron phosphate has a chemical formula of LiFePO₄₋ₓFₓ/C, wherein x ranges from 0.01 to 0.05.

19. The positive electrode plate according to claim 18, wherein the modified porous lithium iron phosphate has a chemical formula of LiFePO_{3.97}F_{0.03}/C.

20. A lithium-ion battery, comprising the positive electrode plate according to claim 17.
